(19) United States
(12) Patent Application Publication
(10) Pub. No.: US 2011/0134625 A1
(43) Pub. Date: Jun. 9, 2011

(54) Illuminated reading material holder and recharging system

(75) Inventor: Gary D. Broxson, Lillian, AL (US)

(73) Assignee: PIRD, LLC, Atlanta, GA (US)

(21) Appl. No.: 12/592,938

(22) Filed: Dec. 4, 2009

(51) Int. Cl. F21V 9/16; A47B 19/00

(52) U.S. Cl. 362/84; 362/98; 362/183

(57) ABSTRACT

An integrated illuminating reading material holder and system for recharging the holder(s) that uses an electro-luminescent sheet positioned parallel to and under a top flat transparent surface. The reading material is adapted to be supported on top of the transparent surface. A multi-slotted recharging station includes contacts in designated slots for recharging the battery of the holder when received in a respective slot. The holder and system may also use light emitting diodes placed around all or a portion of the perimeter of the holder to illuminate the reading material.

### CROSS-REFERENCES TO RELATED APPLICATIONS

This patent is related to, but does not claim priority from, U.S. patent application Ser. No. 11/507,155.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### INCORPORATION-BY-REFERENCE OF MATERIAL SUBMITTED ON A COMPACT DISK

Not Applicable

### BACKGROUND OF THE INVENTION

1. Field of the Invention

This invention pertains to an apparatus for the illumination of reading material and, more particularly, to a rechargeable illuminating reading material holder and system that includes an electro-luminescent panel, LED or other light source(s), and a means to recharge such holder.

2. Background Art

Many devices exist that can be used to illuminate reading material. Some of these devices consist of book holders or covers that illuminate the reading material placed therein. One example of placing a menu in a illuminating folder includes U.S. Pat. No. 5,639,156, issued to Broxson, entitled “ILLUMINATED READING DEVICE” which describes a book-like folder cover that illuminates when the cover is open and tilted at a pre-set angle. The cover includes batteries along the spine and light sources along the perimeter of the cover and along the spine.

Other examples of book holders and covers with illuminating capability include U.S. Pat. No. 3,364,344 issued to Marcellino, U.S. Pat. No. 3,586,847 issued to Nahmias, U.S. Pat. No. 3,823,312 issued to Weinstein, and U.S. Pat. No. 3,885,145 issued to Wise. In all of these devices, a book is placed within the cover or holder and is illuminated by turning an attached lamp either on or off. Some of these lamps are battery operated while others rely upon alternating current for their energy source. Unfortunately, these devices are either not easily portable or they are rather bulky in nature.

A variation of the above is shown in U.S. Pat. No. 1,202,498 issued to Findley, and U.S. Pat. No. 4,908,742 issued to Kersey. In these cases, a writing pad is permanently mounted to a closable cover that can also illuminate the pad if desired. This cover further incorporates a storage area for the storage of notes or even a transistor radio.

Other simple illumination devices do not involve a cover or the like, but instead consist of a portable lamp that can be easily moved from book to book as needed. Such devices are shown in U.S. Pat. No. 2,561,744 issued to Langdon, et al., and U.S. Pat. No. 4,432,042 issued to Zeller. In each of these cases, a battery-operated lamp assembly is mounted to an upper part of the book so as to shine down on the reading material at an angle preferred by the reader. Such devices may be clipped to a number of pages of the book or may be attached to the book cover for greater support. Unfortunately, such lamps provide uneven illumination from top to bottom and side to side since all the light is emitted from a single upper source that is generally located at a mid-page position.

Still another device that assists in the reading of material is shown in U.S. Pat. No. 2,169,786 issued to Baum. In accordance with this invention, a magnifying glass is mounted on a stand that can be moved across the reading material or vice versus. It is particularly adapted for use in reading road maps and the like by drivers and/or tourists. A lamp mounted in the stand provides illumination if such is desired.

Still other devices that assists in the reading of material include clipboards which are shown in U.S. Pat. No. 4,016,666, issued to Finn et al., entitled “CLIPBOARD INCORPORATING WEAPON” disclosing a light on the clip of the clipboard; Design U.S. Pat. No. D418, 877, issued to Brotz, entitled “ILLUMINATED CLIPBOARD WITH STORAGE COMPARTMENT” illustrating an illuminated clipboard; Design U.S. Pat. No. D330,915, issued to Shing-Wai, entitled “COMBINED ILLUMINATED CLIPBOARD AND WRITING INSTRUMENT FOR ATTACHMENT TO AN AUTOMOBILE STEERING WHEEL” illustrating a illuminated clipboard; U.S. Pat. No. 6,443,588, issued to Nunez, entitled “LIGHTED CLIPBOARD DEVICE” disclosing a light on the clip of the clipboard; U.S. Pat. No. 6,241,360, issued to Merrell, entitled “LIGHTED WRITING SUPPORT AND CLIPBOARD” disclosing a clipboard having a light source integrated into the clip; U.S. Pat. No. 5,163,748, issued to Messinger, entitled “ILLUMINATED CLIPBOARD” disclosing a clipboard housing that carries the battery powered electrical circuitry and light sources (LEDs and lamps); U.S. Pat. No. 5,502,623, issued to Bratz, entitled “ILLUMINATED CLIPBOARD” disclosing a clipboard illuminated by LEDs; U.S. Pat. No. 5,607,223, also issued to Bratz, entitled “ILLUMINATED CLIPBOARD WITH MOVABLE WRITING SURFACE” disclosing a clipboard illuminated by a woven fiber optic sheet that extends under the entire area of the transparent body wherein the sheet is illuminated through a fiber optic cable receiving light from a light bulb; and, U.S. Pat. No. 4,745,286, issued to Jones, entitled “LUMINOUS SHEET AND INDICIA” disclosing a sheet of paper or plastic coated with phosphorescence glow on the dark material and a coating of photographic emulsion.

U.S. Pat. No. 4,266,164, issued to Schroeder entitled “ELECTRO-LUMINESCENT BACKING SHEET FOR READING AND WRITING IN THE DARK” discloses a plurality of phosphorescent or electro-luminescent panels that are individually activated to aid a user in writing or reading in low light conditions.

The aforementioned patents are incorporated herein by reference, although no publication is acknowledged or admitted to render any aspect of the present invention non-novel or obvious.

It is an object of this invention to provide a portable, rechargeable illuminating reading material holder with a power supply sufficiently small to be incorporated into the illuminated reading material holder, yet powerful enough to provide uninterrupted power to the electro-luminescent panel, LED, or other light source(s) for an extended period of time.

Still another object of this invention is to provide a rechargeable illuminating reading material holder that can automatically activate the electro-luminescent panel, LED, or other light source(s) or can utilize manual switches or the like.

A further object of this invention is to provide a rechargeable illuminating reading material holder system wherein the holders are recharged when placed in a multi-slotted recharging station.

Yet another object of this invention is to provide a rechargeable illuminating reading material holder comprising a folder structure foldable along a spine that automatically interrupts power to the electro-luminescent panel, LED, or other light source(s) when the folder structure is closed.

It is still another object of this invention to provide a rechargeable illuminating reading material holder adapted for use with menus and the like so that they will be easier to read in dark or underlit areas of a restaurant.

It is still another object of this invention to provide a rechargeable illuminating reading material holder that stands upright and provides illumination in one or more colors.

### SUMMARY OF THE PRESENT INVENTION

The present invention contemplates an illuminating reading material holder for illuminating reading material thereon comprising: a housing having a top flat transparent surface an electro-luminescent sheet positioned parallel to and under said top flat transparent surface; and, an electrical circuit assembly for powering said electro-luminescent sheet located within said housing.

The present invention further contemplates a folder style illuminating reading material holder that automatically closes a switch to energize an electro-luminescent panel when the folder is open and automatically opens the switch to de-energize the panel when the folder is closed.

The present invention further contemplates an illuminating reading material holder system that recharges the holder in a multi-slotted station, each slot receiving a holder.

The present invention further contemplates an illuminating reading material holder system that includes a switch that powers the electro-luminescent panel when the reading material holder is positioned at an preset angle or greater from horizontal that is appropriate for reading.

The above and other objects and features of the present invention will become apparent from the drawings, the description given herein, and the appended claims.

### BRIEF DESCRIPTION OF THE DRAWING

For a further understanding of the nature and objects of the present invention, reference should be had to the following description taken in conjunction with the accompanying drawings in which like parts are given like reference numerals and, wherein:

FIG. 1 illustrates a perspective view of a preferred embodiment of a two-sided folder style illuminating reading material holder of the present invention in the open position;

FIG. 2 illustrates a top layered view of the illuminating reading material holder of FIG. 1 in the open position;

FIG. 3 illustrates a cross-sectional view along the plane 3-3 of FIG. 2;

FIG. 4 illustrates a cross-sectional view along the plane 4-4 of FIG. 2;

FIG. 5 illustrates a partial view of the interior panels of the two-sided folder-style illuminating reading material holder in an open position;

FIG. 6 illustrates a partial end view of the illuminating reading material holder of FIG. 1 in a closed position;

FIG. 7 illustrates a perspective view of a rechargeable illuminating reading material holder system in accordance with the present invention;

FIG. 8 illustrates partial cut away view of the system in accordance with the present invention depicting the charging contacts for a first embodiment;

FIG. 9 illustrates an a perspective view of another embodiment of a rechargeable illuminating reading material holder system in accordance with the present invention multi-folder recharging station;

FIG. 10 illustrates an end view of an alternate embodiment of the illuminating reading material holder for use with station in FIG. 9; and

FIG. 11 illustrates a general block diagram of the electrical circuit assembly in accordance with the present invention.

FIG. 12a depicts a schematic of an electro-luminescent panel driver board (HV 809 DB2) by Supertex. And below that, FIG. 12b depicts the driver as modified in the embodiment of the present invention wherein the driver powers two electro-luminescent panels of approximately 100 square inches each.

FIG. 13a depicts a schematic of an electro-luminescent panel driver board (HV 823 DB1) by Supertex. And below that, FIG. 13b depicts the driver as modified in the embodiment of the present invention wherein the electro-luminescent panel is powered by the driver on the order of 4 to 12 square inches in size.

FIG. 14 depicts a reading material holder with light emitting diodes (140) placed around the perimeter. FIG. 14 also depicts a magnifying reading bar (145) slideably affixed to the reading material holder atop the reading material.

### DETAILED DESCRIPTION OF THE PREFERRED EMBODIMENT

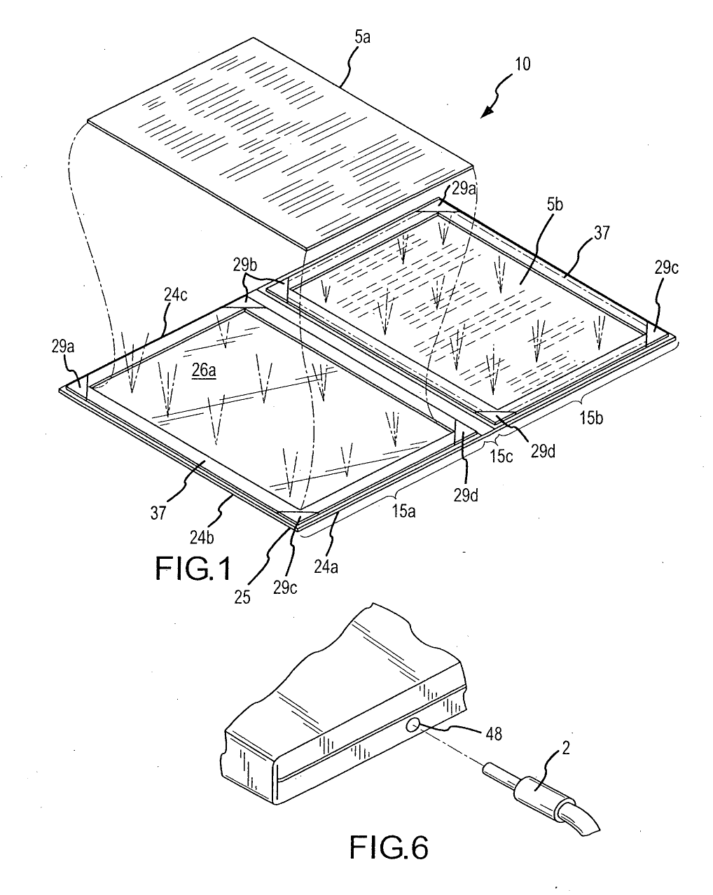

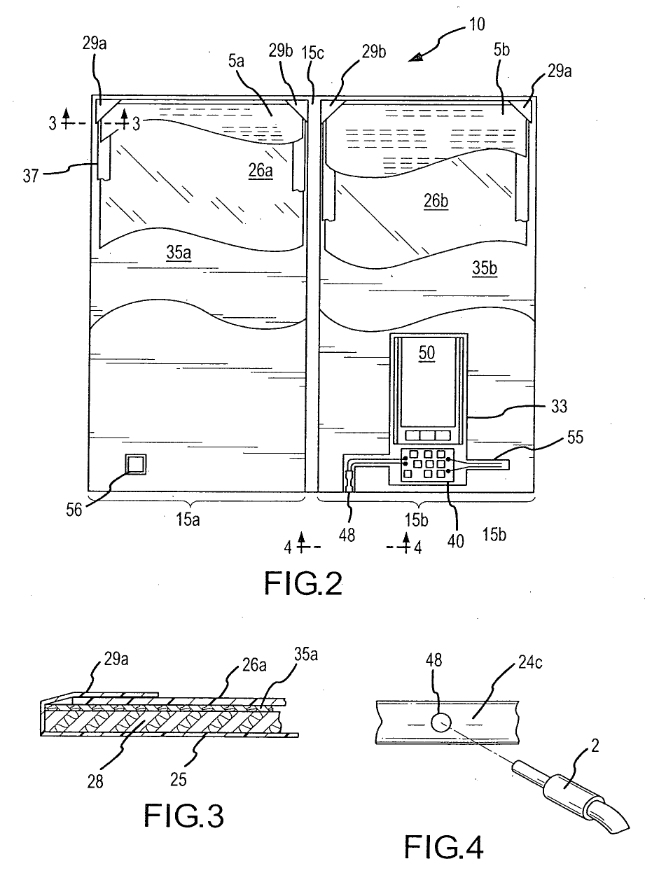

Referring now to the drawings, and in particular FIGS. 1-2, the rechargeable reading material holder of the present invention is generally referenced by the numeral 10. The rechargeable reading material holder 10 comprises, in general, a housing having at least one top transparent planar surface 26a (and 26b in a two-sided illuminating configuration) illuminated by at least one electro-luminescent panel 35a (and 35b). In the exemplary embodiment, each top transparent planar surface 26a (and 26b) is illuminated by a respective electro-luminescent panel 35a (and 35b).

In the preferred embodiment and operation, the rechargeable reading material holder 10 is a menu-holder which is constructed in the form of a book-like folder or cover having two sides 15a and 15b joined together via a center spine or hinge member 15c. The folder or cover supports the illumination sources (electro-luminescent panel 35a and 35b) and electrical circuit assembly 40 therein. Each side 15a and 15b may be at least 8½ by 11 inches in size. Nevertheless other sizes, larger and smaller, may be used.

Because each side 15a and 15b is essentially the same, only one such side will be described in detail. The differences will be described separately. Referring still to FIGS. 1-2, side 15a includes a top transparent planar surface 26a through which the illumination from the electro-luminescent panel 35a is shown. The electro-luminescent panel 35a is adapted to approximate the size of the top transparent surface 26a. As can be appreciated, the entire housing may be made of transparent materials such as plastics, acrylics, etc., with a removable top or bottom surface for insertion of the electro-luminescent panel 35a and electrical circuit assembly 40.

With reference also to FIG. 1, the side 15a further includes three low-profile side surfaces or edges 24a, 24b, and 24c. The fourth side surface is integrated with the spine 15c which joins together sides 15a and 15b and is parallel with edge 24b.

Referring to FIGS. 1 and 3, side 15a includes a plurality of layers. The first layer defines an outer shell or cover 25. The outer shell or cover 25, in an exemplary embodiment, is made of a flexible material, such as, without limitation, vinyl, leather, cloth or other book binding type material adapted to be affixed to cardboard 28 or other rigid material rendering the flexible material rigid. Four top-mounted corner pockets 29a, 29b, 29c and 29d are positioned at the corners of the top transparent surface 26a and are adapted to receive the corners of the reading material 5a. In an exemplary embodiment, the four top-mounted corner pockets 29a, 29b, 29c and 29d are made of the same material as the outer shell or cover 25. Nevertheless, other material for the pockets may be used, provided a corner of reading material 5a can be slid thereunder. Furthermore, in lieu of corner pockets, other fastening mechanisms, such as a clip at the top, bottom and/or side edge of side 15a may be provided to hold the reading materials 5a in place atop the top transparent planar surface 26a.

In an exemplary embodiment, only one of the sides (as pictured in FIG. 2, side 15b) is required to support therein the electrical circuit assembly 40 and battery 50. To accommodate the low profile of the electrical circuit assembly 40 and battery 50, a recessed area 33 is formed in the cardboard 28 or other rigid material to hold such electrical circuit assembly 40 and battery 50 below the electro-luminescent panel 35b. Alternately, the recessed area could of course be formed in side 15a.

As shown in FIG. 1, in an exemplary embodiment, the top surface of the holder 10 includes a frame member 37 around the perimeter of the top surface which may be made of the same material as cover 25. Nevertheless, other material can also be substituted. The frame member 37 allows the transparent surface 26a to be slid thereunder and later removed, if needed. The electro-luminescent panel 35a is sandwiched between the cardboard 28 and the transparent surface 26a.

Referring now to FIGS. 2, 4, and 6, the bottom low-profile side surface or edge 24c of side 15b has a battery recharging jack, port or contact pad 48.

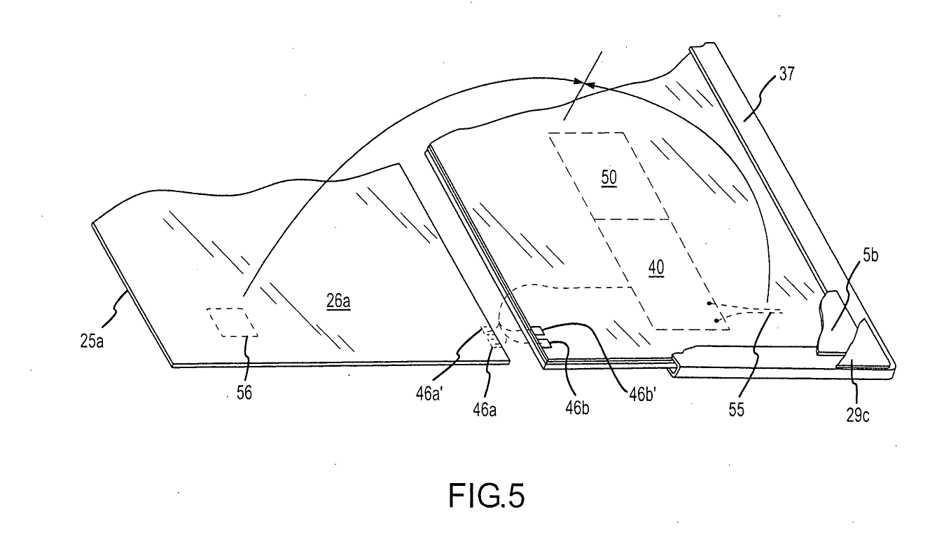

With specific reference to FIGS. 4 and 6, battery recharging jack, port or contact pad 48 is adapted to receive a plug 2 for connection to a power source such as through a wall outlet.

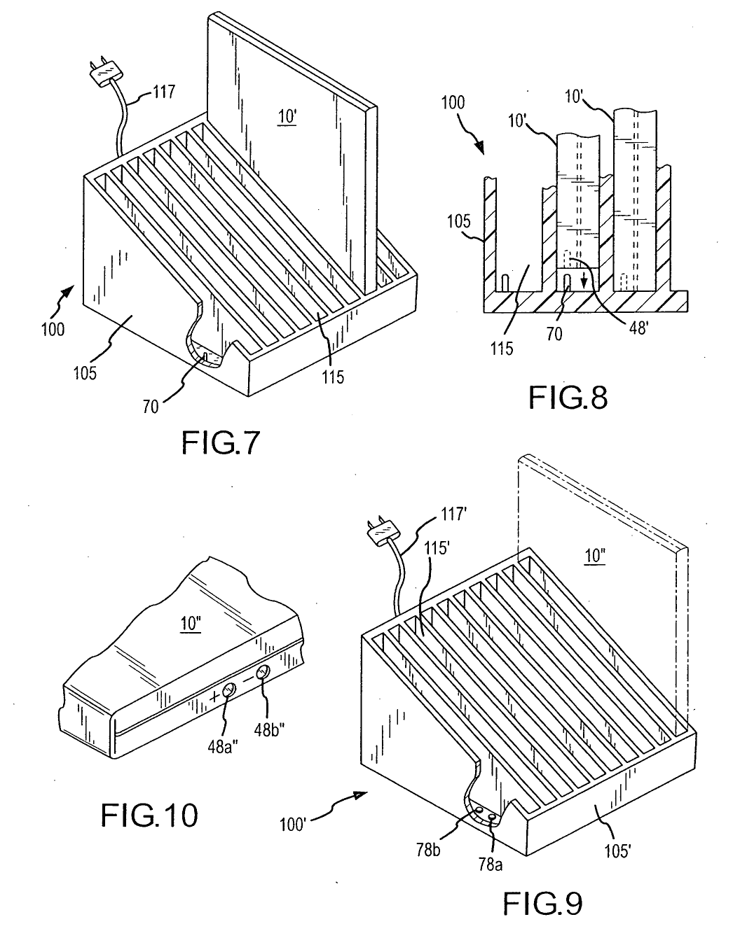

With specific reference to FIGS. 7 and 8, the battery recharging port 48′ is a port adapted to receive a contact lead prong 70 formed in a multi-folder recharging station 105, as will be discussed in more detail later.

With specific reference to FIGS. 9 and 10, in one embodiment the battery recharging port, jack or contact pad includes a pair of contact pads 48a″ and 48b″ adapted to come in direct surface-to-surface contact with a reciprocal pair of contact pads 78a and 78b formed in the multi-folder recharging station 105′.

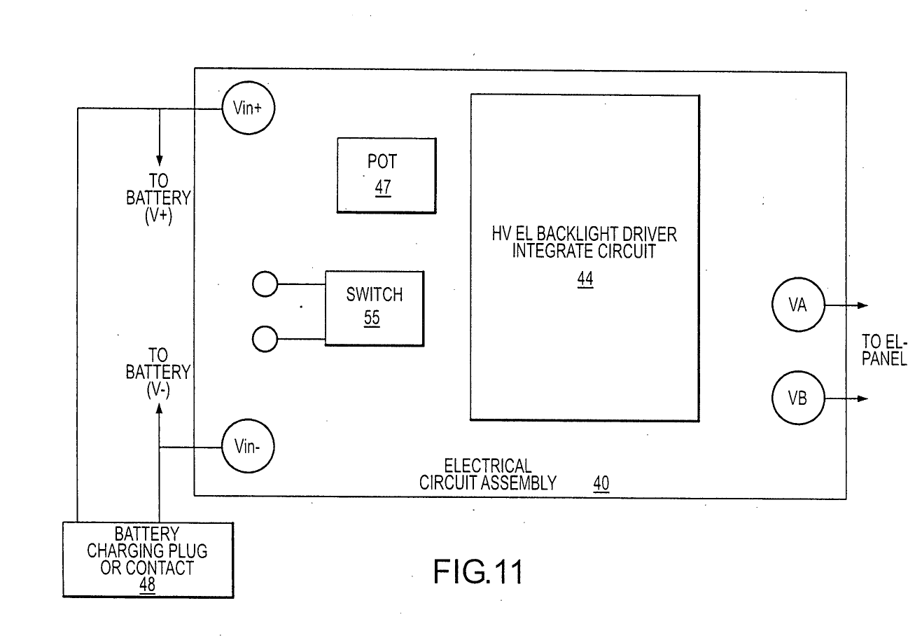

Referring now to FIG. 11, the electrical circuit assembly 40 uses HVCMOS® technology or other integrated circuitry that reduces the size and weight of the electrical circuit assembly 40. This allows an electrical circuit power supply source to be unobtrusively incorporated into the illuminating reading material holder that is able to provide sufficient power for extended usage before recharging. In an exemplary embodiment of a menu sized illuminating reading material holder, the high voltage electro-luminescent backlight driver 44 is a HV809LG by Supertex Inc. (The Material Data Sheets “Off-Line High Voltage EL Lamp Driver” for HV809 and “High Voltage EL Lamp Driver” for HV830 are incorporated herein by reference). Nevertheless other similar low-profile drivers may be substituted. In the preferred embodiment, the HV809LG requires a single driver and has coupled thereto a potentiometer (POT) 47 to vary the inverter frequency or multi-vibrational speed which varies the output voltage VA and VB.

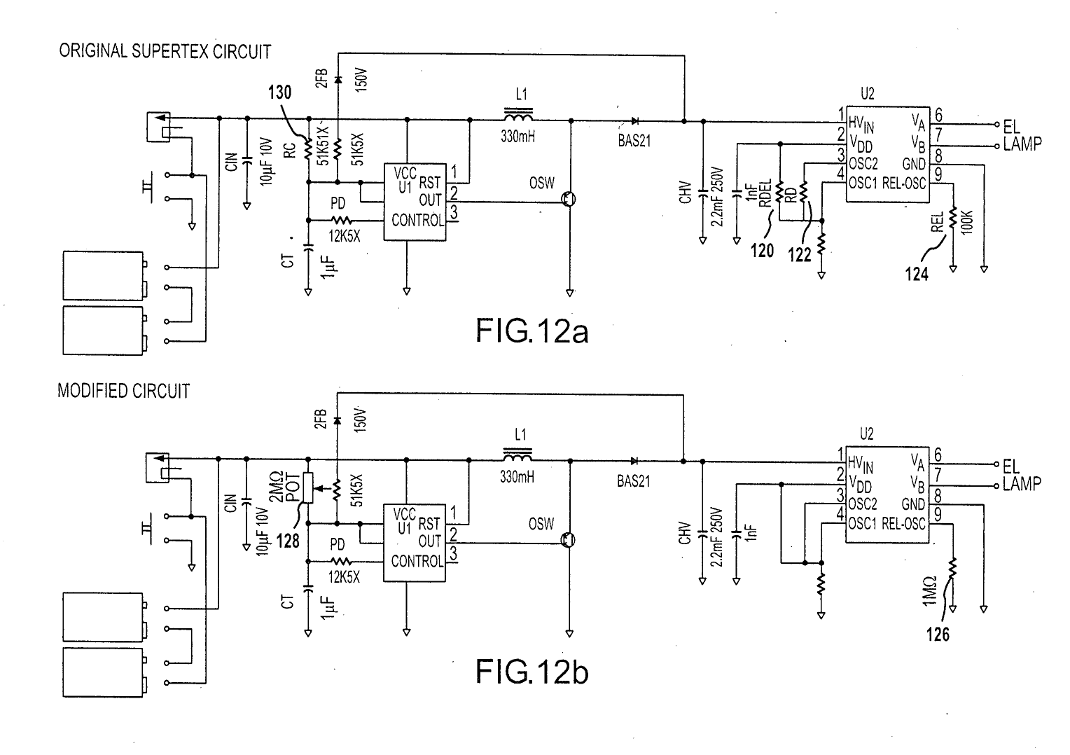

As shown in FIG. 12, the circuitry of the HV809 electro-luminescent lamp driver board by Supertex is modified in order to provide the preferred output to the electro-luminescent panel in terms of frequency and voltage. With an input power supply of 7-13 volts from lithium batteries (discussed below) the HV809 does not provide ideal brightness or battery life. But, by modifying the driver circuit 12a as shown in FIG. 12b, by removing the resistors at 120 and 122, replacing the resistor at 130 with a 1 mega ohm resistor 126 and replacing the resistor at 124 with a 2 mega ohm potentiometer adjusted to approximately 1 mega ohm of resistance, 126, this modification produces the preferred output of frequency 400 Hertz (±10%) and potential difference of 60-100 volts suitable to power two approximately 100 square inch electro-luminescent panels for use in a foldable menu holder. Output may also be variable, preferably in the frequency and potential difference ranges set forth above. Where two electro-luminescent panels are powered by a single electrical circuit assembly, the panels should be connected in series to prevent the inverter from overheating.

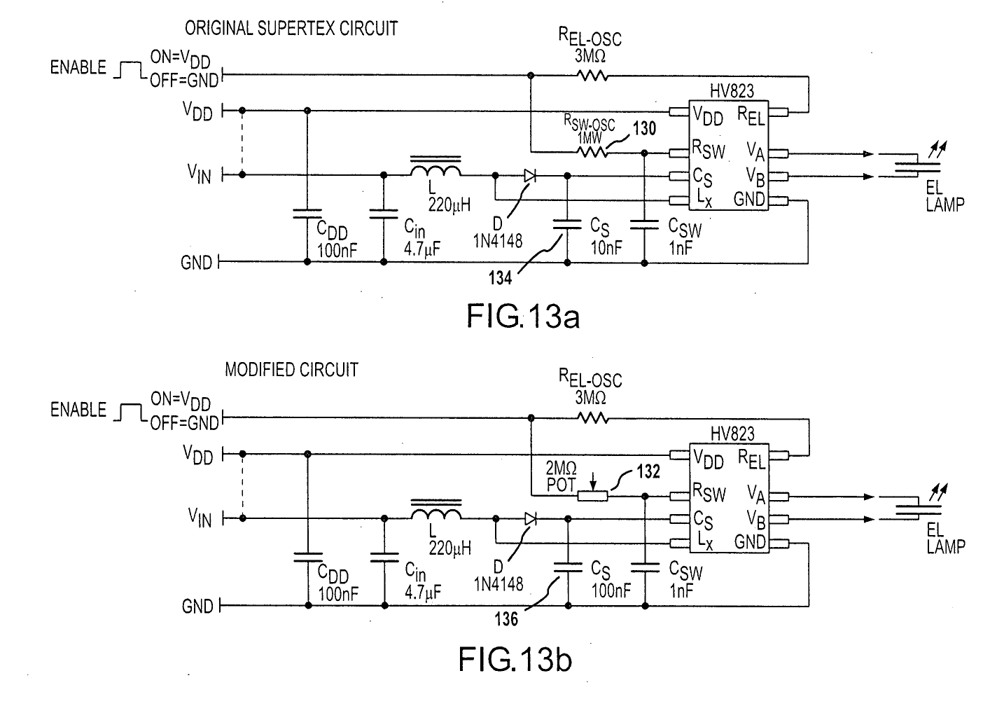

In a smaller embodiment of the present invention, such as a check presentation folder used at restaurants, a modified Supertex HV823 DB1 driver circuit may be used. FIG. 13a depicts a schematic of the standard HV823 DB1 circuit above and the modified circuit 13b below. As shown in FIG. 13, the modified circuit replaces the resistor 130 with a 2 mega ohm potentiometer adjusted to approximately 1 mega ohm of resistance 132. In addition, the modified circuit replaces the 10 nF capacitor 134 with a 100 nF capacitor 136. This modification produces a desired output to illuminate an electro-luminescent panel from 4-12 square inches in size. That desired output is a frequency of 400 Hz (±10%) and a potential difference of 65-100 volts from an input of 3 to 6 volts from a direct current battery.

The change in the output voltage VA and VB allows the intensity of the electro-luminescent panel 35a (and if included 35b) to be varied or set at the factory. The ability to vary output voltage VA and VB and thereby vary the intensity of the electro-luminescent panel 35a (and 35b) allows for maximization of battery life.

Battery life may also be maximized by using smart battery technology which is well-known in the industry. In addition, battery chips can monitor charging and temperature for safety.

The electrical circuit assembly 40 is preferably powered by a rechargeable lithium battery 50 (see FIGS. 2 and 5) to provide Vin+ and Vin− to the electrical circuitry assembly 40. The battery 50 is generally shaped in the form of a low-profile parallelogram. In an exemplary embodiment of the two-panel menu holder, the battery 50 is two rechargeable 3.7 v Lithium batteries by Varta PoLiFlex®-PLF 383562. These batteries have a low-profile height of approximately 3.8 mm and a weight of approximately 15 grams. Other size and shape batteries may be used provided the battery has a low-profile height to minimize the height of the housing illuminated reading material holder 10. The term low-profile is herein defined to mean a structure that has a low height, preferably less than 4 mm.

The electrical circuit assembly 40 includes a circuit board. The circuit board includes contacts to a switch 55, such as a reed switch, for activating the electrical circuit assembly 40. Power is delivered from battery 50 to the electrical circuit assembly 40 which drives the electro-luminescent panels 35a and 35b.

Referring to FIG. 5 a magnetic pad 56 is placed on side 15a opposite a reed switch 55 on side 15b. Thus, when sides 15a and 15b are closed so that the top surfaces are in close proximity, reed switch 55 is open and interrupts power to the battery 50. Alternately, when the sides 15a and 15b are open magnetic pad 56 and reed switch 55 are not in close proximity and the reed switch 55 automatically closes and delivers power from battery 50 to the circuit assembly 40 and on to electro-luminescent panels 35a and 35b.

The electrical circuit assembly 40 further includes at least one contact pad 46a (and 46a′) to deliver power to the electro-luminescent panel 35a and at least one contact pad 46b (and 46b′) to deliver power to the electro-luminescent panel 35b, as best seen in FIG. 5.

Alternatively to, or in conjunction with, using a reed switch, the illuminating reading material holder of the present invention may use a tilt switch such as is depicted in U.S. Pat. No. 5,639,156. In this embodiment, the electro-luminescent panels are powered only when the reading material holder is held up and tilted at a preset angle or greater from the horizontal position. In this way, when the invention is used to illuminate a menu, the menu will not be illuminated when laid flat on a table, but will illuminate when picked up to be read by a restaurant patron.

As can be appreciated, the combination of rechargeable reading material holder 10 and reading materials 5a (and 5b) may provide an illuminated or back-lit menu or other holder of reading or viewing material. For best operation, reading materials 5a (and 5b) would be constructed of thin relatively transparent material so that such light can pass through them.

In other embodiments, the reading materials 5a (and 5b) may consist of cut-out stencil(s) through whose openings light from the electro-luminescent panel(s) passes. In any event, the backlighting provided by illumination sources (electro-luminescent panels 35a (and 35b)) highlights the differences between the words written upon reading material 5a (and 5b) and the blank spaces or areas where nothing is written. This contrast between the two makes it easier for the reading material 5a (and 5b) to be read.

In a preferred embodiment, reading material 5a (and 5b) is a two-sheet menu or a menu and wine or beverage list of a restaurant wherein, upon the opening of reading material holder 10, or opening and tilting, the electro-luminescent panels 35a (and 35b) are automatically activated so as to illuminate reading materials 5a (and 5b). Such activation will aid the user in clearly seeing reading materials 5a (and 5b) in dark or under-lit locations. The electro-luminescent panels 35a (and 35b) may illuminate a variety of colors some of which have a neon-type appearance. The neon-type lighting adds to the novelty of the illumination of the reading materials 5a (and 5b) especially in contemporary restaurants.

Returning again to FIGS. 7 through 10, the embodiments of the rechargeable illuminating reading material holder systems 100 and 100′ are shown. System 100 includes holder 10′ and multi-folder recharging station 105. The multi-folder recharging station 105 includes single dock with a plurality of receiving slots 115 dimensioned to receive a portion of holder 10′ upright and in a closed position. Each slot 115 includes a respective lead prong 70. Thus, when the holder 10′ is received in the slot 115, the battery recharging port 48′ is aligned with and receives the contact lead prong 70.

With specific reference to FIG. 9, System 100′ includes holder 10″ and multi-folder (battery) recharging station 105′. The multi-folder recharging station 105′ includes a single dock with a plurality of receiving slots 115′ dimensioned to receive a portion of holder 10″ upright and in a closed position. Each slot 115′ includes a pair of contact pads 78a and 78b. Thus, when the holder 10″ is received in the slot 115′, the battery recharging port 48a″ and 48b″ are aligned with the pair of contact pads 78a and 78b so that they come into surface-to-surface contact.

The multi-folder recharging stations 105 and 105′ have coupled thereto a power cord 117 and 117′, respectively, for connection to a wall outlet or other power supply to recharge the holders 10′ and 10″.

The multi-slotted recharging stations 105 and 105′ comprise a single dock having a back wall, a front wall, two side walls, a bottom surface and a plurality of dividing walls to form the plurality of slots. In the preferred embodiment, the back wall of the docks 110 and 110′ is higher than the front wall with side walls tapering back to front. The configuration aids in placing the holders 10′ and 10″ in the recharging station and in keeping the holders upright during recharging.

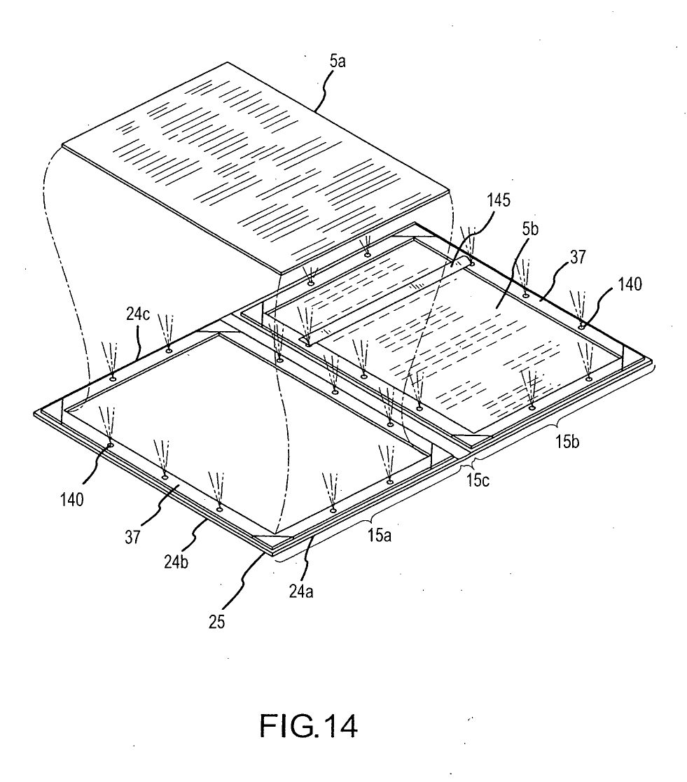

FIG. 14 depicts a reading material holder that incorporates light emitting diodes (140) placed around the perimeter to illuminate the reading material. A magnifying reading bar (145) may be affixed to the reading material holder to magnify the reading material and make it easier to read. The reading bar may be affixed by way of connection to tracks in the reading material holder that it slides in or other affixing methods that are known to those skilled in the art.

It should here be stated that while the following description is with respect to the reading of a menu, this invention may also be used in other locations and for other purposes such as those that may involve a clip-board or a notebook. Consequently, this invention can be used in educational, industrial or business locations as well as in commercial or retail establishments. In any event, this invention can be used wherever portable illumination of reading and/or writing material is desired. It need not be limited solely to the reading of menus in restaurants.

In one such other preferred embodiment, referring to FIG. 2, the illuminating reading material holder consists of a single panel or side 15b, with no foldable spine. The illuminating reading material holder stands upright by way of a base with a single receiving slot, 115 of FIG. 7, or other support such as are well known to those of skill in the art. The illuminating reading material holder illuminates in white, or one or more other colors. Different colors may be used to indicate different signals. For example, a white illumination could be used to illuminate the reading material, but a switch could change the white to another color via different colored LEDs or other means to indicate, for example, that a patron at a restaurant wanted a server to come take an order. In addition, it should be noted that the present invention can readily be incorporated into shapes other than a rectangle, including a triangle, trapezoid, cylinder or other geometric shape.

Other applications for the invention disclosed herein include, but are not limited to, use as a check holder so that restaurant patrons can easily read their bill; use by law enforcement officers to illuminate ticket pads or other materials that may be read or written upon in low light conditions; use by medical personnel for reading charts or examining x-rays; use as a picture frame to illuminate photographs or other viewing material; and as a night light.

Because many varying and differing embodiments may be made within the scope of the inventive concept herein taught and because many modifications may be made in the embodiments herein detailed in accordance with the descriptive requirement of the law, it is to be understood that the details herein are to be interpreted as illustrative and not in a limiting sense.

What is claimed as invention is:

1. An illuminated reading material holder recharging system comprising:
a. a plurality of illuminating reading material holders, each holder illuminated by an electro-luminescent sheet;
b. electric circuitry assembly and battery located in each illuminating reading material holder for powering each said electro-luminescent sheet;
c. a contact point on said holder for connecting said holder to a recharging source; and
d. a multi-slotted recharging station having a single back wall, a single front wall, two side walls, a bottom surface, and a plurality of dividing walls to form a plurality of slots, each slot adapted to receive one of said holders.

2. The system of claim 1, wherein each holder includes a transparent surface positioned above said electro-luminescent sheet.

3. The system of claim 1, wherein said illuminated reading material holder has a first and a second side foldable about a spine.

4. The system of claim 3, wherein said illuminated reading material holder includes a switch that remains open when said holder is in a closed position and closes to provide power to said electro-luminescent panel when said holder is opened.

5. An illuminated reading material holder comprising:
e. a housing having a flat transparent surface;
f. an electro-luminescent sheet positioned under said flat transparent surface;
g. a rechargeable lithium battery of thickness less than 5 mm; and
h. an electrical circuit as depicted in FIG. 12(b), including an inverter producing output in the range of 60-100 volts at 400+/−40 Hz, from a direct current input of 3 to 12.8 volts.

6. The illuminated reading material holder of claim 5, including an electrical circuit as depicted in FIG. 13(b), including an inverter capable of producing output in the range of 65 to 100 volts at 400+/−40 Hz from a direct current input of 3 to 6 volts.

7. A method for illuminating reading material comprising;
a. providing one or more illuminating reading material holders each consisting of a first side and a second side joined together by and foldable along a spine;
b. providing an electro-luminescent sheet positioned on at least one of said first and second side; and
c. powering said electro-luminescent sheet via a rechargeable smart battery and an electrical circuit assembly as depicted in FIG. 12(b) contained within said reading material holder.

8. The method of claim 7, including providing power from said electrical circuit assembly through a circuit as depicted in FIG. 13(b).

52-53. (canceled)

9. The method of claim 7, including providing a multi-slot recharging station for recharging said holders comprising a single dock having a single back wall, a single front wall, two side walls, a bottom surface and a plurality of dividing walls to form said plurality of slots wherein said holders connect to an area of said multi-slot recharging station residing in each said slot in order to recharge said battery.

10. The method of claim 7, wherein said electrical circuit assembly converts direct current battery voltage of 3-12.8 volts to output in the range of 60-100 volts at a frequency of 400+/−40 Hz via an inverter.

11. An illuminating reading material holder comprising:
a. a rigid housing having a flat transparent surface;
b. a plurality of light-emitting diode illumination sources affixed around all or a portion of the perimeter of said housing;
c. a rechargeable battery located within said housing;
d. an electrical circuit for powering said light-emitting diodes; and
e. a base to support said holder in a vertical position.

12. The illuminating reading material holder of claim 11 including:
a. light-emitting diodes capable of producing different colors; and
b. a switch for powering the light-emitting diodes to produce one or more colors.

13. The illuminated reading material system of claim 11, including a base, separate from said multi-slot recharging station, to support said holder in a vertical position.

14. The method for illuminating reading material of claim 17, including supporting said holder in a vertical position with a base.
